(19) United States
(12) Patent Application Publication
(10) Pub. No.: US 2009/0140658 A1
(43) Pub. Date: Jun. 4, 2009

(54) LIGHT EMITTING DEVICE, METHOD OF DRIVING THE SAME, AND ELECTRONIC APPARATUS

(75) Inventors: Hiroaki JO, Suwa-shi (JP); Tsukasa EGUCHI, Matsumoto-shi (JP); Eiji KANDA, Suwa-shi (JP); Toshiyuki KASAI, Okaya-shi (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/325,500

(22) Filed: Dec. 1, 2008

(30) Foreign Application Priority Data
Dec. 4, 2007 (JP) 2007-313255
Nov. 17, 2008 (JP) 2008-293064

(51) Int. Cl. H05B 37/02

(52) U.S. Cl. 315/155; 315/156

(57) ABSTRACT

There is provided a method of driving a light emitting device including a light emitting element and a unit circuit that is disposed in correspondence with the light emitting element and drives the tight emitting element in accordance with emission control data generated based on image data, wherein the light emitting device has a temperature sensor and a light receiving sensor. The method includes detecting the temperature of the light emitting device by using the temperature sensor, detecting light emitted from the light emitting element by using the light receiving sensor, and generating the emission control data by correcting the image data in response to the temperature of the light emitting device which is detected by the temperature sensor and the detected value of light which is detected by the light receiving sensor.

### BACKGROUND

1. Technical Field

The present invention relates to a light emitting device, a method of driving the light emitting device, and an electronic apparatus, and more particularly, to a light emitting device using various light emitting elements such as an organic light emitting diode (hereinafter, referred to as an OLED), a method of driving the light emitting device, and an electronic apparatus.

2. Related Art

In electronic apparatuses such as image forming apparatuses of xerographic type, as an optical head that is used for forming an electrostatic latent image on an image carrier such as a photosensitive drum, a light emitting device in which a plurality of LED elements or OLED elements is disposed on a substrate is used.

Generally, an optical head that uses the LED elements or the OLED elements as the light emitting elements selectively turns on (light emission) the light emitting elements near a photosensitive body, and the emitted color is projected on the photosensitive body as exposure light. Accordingly, in an image forming apparatus in which the above-described optical head is mounted, a moving part such as a rotary polygon mirror, which is included in an image forming apparatus using a laser diode, is not included, and thus, the image forming apparatus has high reliability and a high degree of silence. In addition, in the above-described image forming apparatus, an optical system that guides light emitted from a laser diode to the photosensitive body and a large optical space that becomes a light path are not needed, and accordingly, the image forming apparatus can be miniaturized.

In particular, in the optical head using OLED elements as the light emitting element, a drive circuit that is configured by a switching element formed by a thin film transistor (hereinafter, referred to as a TFT) and the OLED element can be formed integrally as one body on a substrate such as glass, and accordingly, the structure and a manufacturing process thereof are simple. Therefore, miniaturization and low cost of the optical head using the OLED elements can be implemented further, compared to an optical head using LEDs as the light emitting elements.

However, on the other hand, it is known that so-called degradation of the light amount of the OLED element in which the emission intensity gradually decreases occurs. Thus, in order to maintain the emission intensity of each OLED element to be in a state equivalent to its initial state, a process for correcting the emission intensity is needed.

For examples the degradation of the light amount occurs in proportion to the emission time. Accordingly, there is bias of emission time for an OLED element having a high use frequency and an OLED element not having a high use frequency. Therefore, individual emission intensity correction for each OLED element is needed.

In addition, it is known that the emission intensity of the OLED element is dependent on the temperature. The dependence on the temperature is determined based on organic materials that configure the OLED element. The OLED may have a positive characteristic in which the emission intensity thereof increases as the temperature rises or a negative characteristic that is a characteristic opposite to the positive characteristic. In an image forming process in the above-described image forming apparatus of xerographic type, a process for fixing a toner image formed on a recording sheet by using heat and pressure is included, and a heat source that dissipates large amount of heat is included inside the image forming apparatus. Accordingly, the emission intensity of the OLED element changes in accompaniment with a change in the temperature inside the image forming apparatus.

For correcting the emission intensity in an image forming apparatus in which an optical head using general OLED elements is mounted, for example, a configuration disclosed in JP-A-2004-082330 has been known. In JP-A-2004-082330, an exposure device (light emitting device) has a configuration in which light receiving sensors are disposed on a glass substrate in which the OLED elements are formed and the emission intensity of each OLED element is detected by using the light receiving sensors.

In addition, in JP-A-2004-082330, the emission intensity Pgn of the n-th OLED element of the exposure device is detected by a test jig in advance, and at this moment, the emission intensity Phn is detected by the above-described light receiving sensors. Then, a correction coefficient Pgn/Phn is calculated based on the emission intensity of the OLED element and the emission intensity detected by the light receiving sensors, and the correction coefficient is stored in the exposure device or a storage unit that is mounted in the image forming apparatus. After the exposure device is installed to the image forming apparatus, a new drive current and the like of the OLED element are determined based on the result of detection of the amount of light by using the above-described light receiving sensors and the correction coefficient stored in the storage unit. Thereby, the initial emission intensity of the OLED element can be maintained all the time by determining the new drive current and the like of the OLED element.

In addition, in JP-A-2004-082330, an operation for correcting the emission intensity can be performed based on a direction of a printer controller at one time point among a time point for an initialization operation performed right after driving the image forming apparatus, a time point before start of print, and a time point at intervals between sheets,

However, since the characteristic of the OLED element changes in accordance with the temperature, the temperature of the OLED element at the time of detection changes depending on a timing at which the operation for detecting the amount of light is performed. As a result, there is a problem that the amount of light cannot be correctly detected.

In addition, when the light receiving elements are formed on the glass substrate, there is a problem that irregularity of characteristic of a light path from the OLED element to the photosensitive body cannot be corrected. Accordingly, a light emitting device that can perform a light amount detecting process with high precision in consideration of irregularity of the characteristic of the light path without dependence on the temperature characteristic of the OLED element and can appropriately correct the emission intensity of the OLED element and a method of driving the OLED element have been demanded.

### SUMMARY

An advantage of some aspects of the invention is that it provides a light emitting device, a method of driving the light emitting device, and an electronic apparatus. The invention can be implemented in the following forms or application examples.

### APPLICATION EXAMPLE 1

According to a first application example of the invention, there is provided a method of driving a light emitting device including: a light emitting element; and a unit circuit that is disposed in correspondence with the light emitting element and drives the light emitting element in accordance with emission control data generated based on image data. The light emitting device has a temperature sensor and a light receiving sensor. The above-described method includes: detecting the temperature of the light emitting device by using the temperature sensor; detecting light emitted from the light emitting element by using the light receiving sensor; and generating the emission control data by correcting the image data in response to the temperature of the light emitting device which is detected by the temperature sensor and the detected value of light which is detected by the light receiving sensor.

According to the above-described method, even when the light emitting element of which emission intensity changes in accordance with the temperature is used, the emission control process is performed for the light emitting element in response to the temperature and the detected value of light at a time when the light emitting element is driven to emit light. Accordingly, the emission intensity of the light emitting element that changes in accordance with the temperature can be detected with high accuracy, and thus, it is possible to correct the image data correctly so as to generate the emission control data. As a result, the emission intensity of the light emitting element can be corrected appropriately (for example, to the initial emission intensity).

### APPLICATION EXAMPLE 2

According to a second application example of the invention, in the above-described method, in the generating of the emission control data, the detected value is converted into an effective value, and the emission control data is generated by using the effective value as the detected value.

When the detection sensitivity of the light receiving sensor is high, the detected value varies markedly. Thus, in such a case, the detected value is converted into an effective value. Accordingly, the detected data is averaged, and thus, the irregularity of detection is suppressed. As a result, the accuracy of the detected value is improved, and the image data can be corrected correctly. Accordingly, it is possible to correct the light emitting element to have an appropriate emission intensity.

### APPLICATION EXAMPLE 3

According to a third application example of the invention, in the above-described method, in the generating of the emission control data, the emission control data is generated by correcting the image data in response to the detected value such that the correction characteristic for generating the emission control data is non linear.

There is a case where the emission intensity (amount of light emission) of a light emitting element has a non-linear characteristic (for example, gamma characteristics) with respect to the drive voltage (current). In such a case, by performing a non-linear correction process for the image data so as to compensate for the non-linear characteristic, the amount of light emission of the light emitting element can be corrected for the image data correctly. As a result, it is possible to correct the light emitting element to have an appropriate emission intensity.

### APPLICATION EXAMPLE 4

According to an application example 4 of the invention, in the above-described method, the light emitting device further includes a light-harvesting lens array that collects light of the light emitting element, and, in the generating of the emission control data, the image data is corrected in response to the positional relationship between the light emitting element and the light-harvesting lens array.

There is a case where the amount of light at a time when the light is emitted from a light-harvesting lens array is irregular with respect to the original emission intensity of the light emitting element in accordance with the positional relationship between the light-harvesting array and the light emitting element. In such a case, by correcting the irregularity in advance, the emission control data can be generated by correcting the image data correctly.

### APPLICATION EXAMPLE 5

According to an application example 5 of the invention, in the above-described method, in the detecting of the light, the light emitted from the light emitting element is detected by using a plurality of the light receiving sensors, and, in generating of the emission control data, the image data is corrected in response to detected values detected by the plurality of the light receiving sensors.

According to the above-described method, light (amount of light) emitted from the light emitting element is detected by using a plurality of the light receiving sensors, and accordingly, the accuracy of detection can be improved. As a result, by correcting the image data in accordance with detected values of the plurality of light receiving sensors, the emission control data can be generated by correcting the image data correctly.

### APPLICATION EXAMPLE 6

According to application example 6 of the invention, in the above-described method, in the generating of the emission control data, the image data is corrected by using a conversion table in which a correction value that is used for correcting the image data in response to the detected temperature and the detected value of light is defined.

According to the above-described method, the image data is corrected by using the conversion table, and accordingly, the process load for performing the correction process for the image data can be decreased.

### APPLICATION EXAMPLE 7

According to application example 7 of the invention, in the above-described method, the correction value of the conversion table is acquired by performing a predetermined calculation process for the correction value set for at least one temperature that becomes a reference.

According to the above-described method, the number of the conversion tables to be included can be decreased, and accordingly, the storage amount can be decreased. In addition, the image data can be corrected correctly at an arbitrary temperature.

### APPLICATION EXAMPLE 8

According to application example 8 of the invention, in the above-described method, the detecting of the temperature includes detecting whether the temperature of the light emitting device is a specified temperature, and, in the detecting of the light, after detecting that the temperature of the light emitting device is the specified temperature in the detecting of the temperature, light emitted from the light emitting element is detected,

According to the above-described method, the correction process is performed at a specified temperature, that is, a constant temperature all the time, and accordingly, the emission control data can be generated by correcting the image data correctly.

### APPLICATION EXAMPLE 9

According to application example 9 of the invention, in the above-described method, in the detecting of light, light emitted from the light emitting element is detected at a plurality of the specified temperatures.

According to the above-described method, the correction process is performed at a plurality of specified temperatures. Accordingly, for example, when the specified temperatures are set in the temperature range of the light emitting device that can be taken at a time when the light emitting device is used, that is, at a time when the light emitting element is driven to emit light, the emission control data can be generated by correcting the image data correctly even in a case where the considered temperature range at the time of use is long.

### APPLICATION EXAMPLE 10

According to application example 10 of the invention, in the above-described method, the image data is either On data that is used for allowing the light emitting element to emit light or Off data that is used for not allowing the light emitting element to emit light, and, in the generating of the emission control data, the emission control data is generated by correcting the image data in a case where the image data is the On data, and the emission control data is generated without correcting the image data in a case where the image data is the Off data.

According to the above-described method, the correction process is not performed for the Off data, and accordingly, the process load for performing the correction process can be decreased. In addition, the circuit configuration needed for the correction process can be simplified.

### APPLICATION EXAMPLE 11

According to application example 11, in the above-described method, the light emitting device further includes a counter that acquires data used for calculating the number of times of light emission of the light emitting element, and, in the detecting of light, light emitted from the light emitting element is detected after it is determined that the number of times of the light emission reaches a predetermined number of times based on the acquired data.

The amount of light emitted from the light emitting element degrades (decreases) in response to the number of times of light emission that relates to the emission time. Thus, for example, by acquiring data used for calculating the number of times of the light emission of the light emitting element and detecting light emitted from the light emitting element at a time when the number of times of light emission reaches a predetermined value, the degraded state of the light emitting element can be detected. Accordingly, the emission control data can be generated by correcting the image data correctly in accordance with the degraded state of the light emitting element.

### APPLICATION EXAMPLE 12

According to application example 12 of the invention, there is provided a light emitting device including: a light emitting element; a unit circuit that drives the light emitting element to emit light; a temperature sensor that detects the temperature of the light emitting device; a light receiving sensor that detects light emitted from the light emitting element; and a control unit that generates emission control data by correcting image data in response to the temperature of the light emission device which is detected by the temperature sensor and a detected value of light which is detected by the light receiving sensor. The unit circuit drives the light emitting element to emit light in response to the emission control data that is generated based on the image data,

According to the above-described light emitting device, the emission control process is performed for the light emitting element in accordance with the temperature and the detected value (for example, the amount of light) of light at a time when the light emitting element is driven to emit light, even in a case where the light emitting element of which characteristic changes in accordance with the temperature is used. Accordingly, the amount of light emission of the emission element of which characteristic changes in accordance with the temperature can be detected with high accuracy, and thus, the emission control data can be generated by correcting the image data correctly. As a result, it is possible to correct the light emitting element to have an appropriate emission intensity.

### APPLICATION EXAMPLE 13

According to application example 13 of the invention, there is provided an electronic apparatus including the above-described light emitting device.

The above-described light emitting device is included in various electronic apparatuses. A typical example of the electronic apparatus is an image forming apparatus of xerographic type in which the light emitting device according to the above-described application example is used as an exposure device for an image carrier such as a photosensitive drum. In the image forming apparatus, the amount of light emission of the light emitting element can be detected with high accuracy. Accordingly, the emission control data can be generated by correcting the image data correctly. As a result, the image forming apparatus (electronic apparatus) capable of correcting the emission intensity of the light emitting element correctly for the image data can be provided.

### BRIEF DESCRIPTION OF THE DRAWINGS

The invention will be described with reference to the accompanying drawings, wherein like numbers reference like elements.

FIG. 1 is a perspective view showing a partial configuration of an image forming apparatus according to a first embodiment of the invention.

FIG. 2 is a diagram showing a schematic configuration of a light emitting device according to the first embodiment.

FIG. 3 is a circuit diagram of a pixel circuit of a drive circuit according to the first embodiment.

FIG. 4 is a diagram showing a detection-correction LUT according to the first embodiment.

FIG. 5 is a diagram showing a detection register according to the first embodiment.

FIG. 6 is a diagram showing a correction according to the first embodiment.

FIG. 7 is a diagram showing a correction register according to the first embodiment.

FIG. 8 is a flowchart showing a detection control method according to the first embodiment.

FIG. 9 is a diagram showing a schematic configuration of a light emitting device according to a second embodiment of the invention.

FIG. 10 is a flowchart showing a detection control method according to the second embodiment.

FIG. 11 is a diagram showing a detection-correction LUT according to a third embodiment of the invention.

FIG. 12 is a diagram representing appearance of generating a detection-correction LUT according to the third embodiment by performing a calculation process.

FIG. 13A is a diagram representing appearance of generating a detection-correction LUT corresponding to an arbitrary temperature according to the third embodiment by performing a calculation process in a case where the number of reference detection-correction LUT is one.

FIG. 13B is a diagram representing appearance of generating a detection-correction LUT corresponding to an arbitrary temperature according to the third embodiment by performing a calculation process in a case where the number of reference detection-correction LUTs is two.

FIG. 14 is a perspective view showing a detailed example (image forming apparatus) of an electronic apparatus according to an embodiment of the invention.

FIG. 15 is a perspective view showing a detailed example (image forming apparatus) of another electronic apparatus according to an embodiment of the invention.

### DESCRIPTION OF EXEMPLARY EMBODIMENTS

### First Embodiment

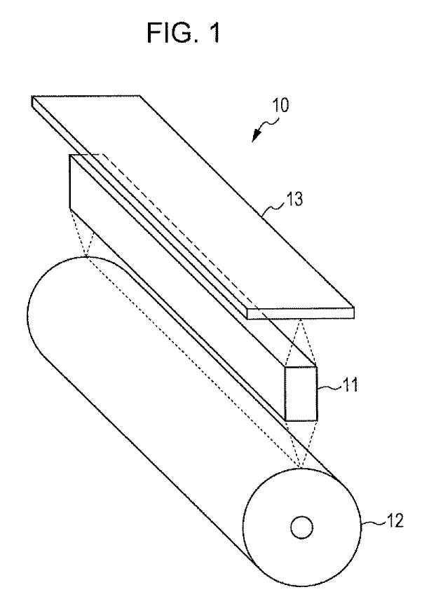

FIG. 1 is a perspective view showing a partial configuration of an image forming apparatus that uses a light emitting device 10 according to a first embodiment of the invention. As shown in the figure, the image forming apparatus includes a light emitting device 10, a light-harvesting lens array 11, and a photosensitive drum 12 as an image carrier. The light emitting device 10 includes a plurality of light emitting elements (not shown in FIG. 1) that are arranged on the surface of a substrate 13 in the shape of a straight light. The light emitting elements selectively emit light in accordance with the form of an image, that is, image data to be printed on a recording material such as a paper sheet. The photosensitive drum 12 is supported by a rotation shaft that extends in the main scanning direction that is also the direction of arrangement of the light emitting elements and is rotated in the sub scanning direction in which the recording material is transported in a state in which the outer peripheral surface thereof is brought to face the light emitting device 10.

The light-harvesting lens array 11 is disposed in a gap between the light emitting device 10 and the photosensitive drum 12. The light-harvesting lens array 11 includes a plurality of gradient index lenses that is arranged in the shape of an array with optical axes thereof postured toward the light emitting device 10. As the light-harvesting lens array 11, for example, there is an SLA (Selfoc) lens array (registered trademark) that is manufactured by Nippon Sheet Glass Company Ltd.

Light emitted from each light emitting element of the light emitting device 10 is transmitted through each gradient index lens of the light-harvesting lens array 11 and then, reaches the surface of the photosensitive drum 12. The surface of the photosensitive drum 12 is exposed by the emitted light. Accordingly, a latent image (electrostatic latent image) corresponding to desired image data is formed in accordance with the exposed part. In this embodiment, a minimum unit that is formed by emission of each light emitting element and controls the area of the exposed part is referred to as a “dot”. Thus, the area of the exposed part is formed by a set of dots.

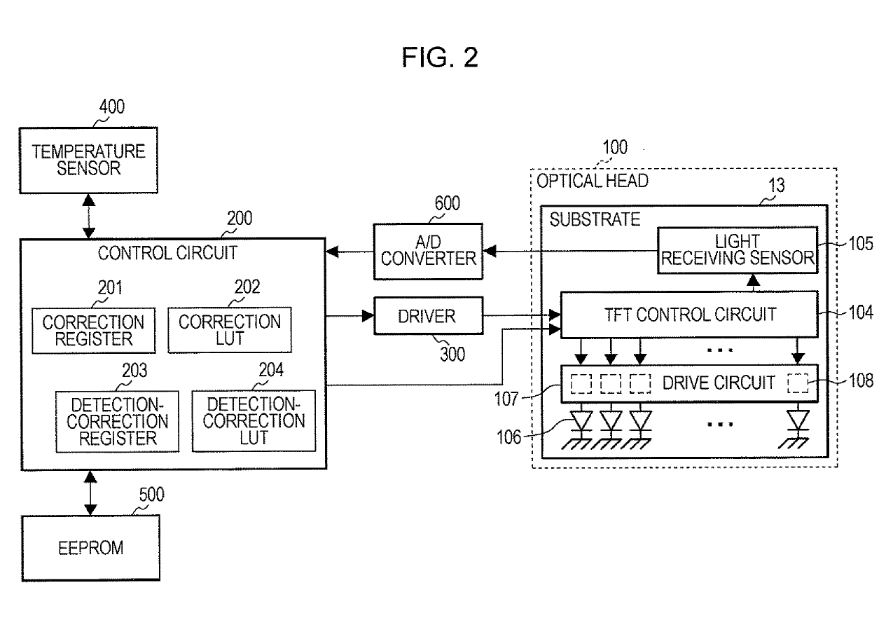

FIG. 2 is a diagram showing a schematic configuration of the light emitting device 10. The light emitting device 10 includes, as circuits for driving an optical head 100, a control circuit 200, a driver 300 that outputs a driving voltage, a temperature sensor 400 that detects the temperature of the inside of an image forming apparatus (for example, a printer) in which the light emitting device 10 is built, an EEPROM 500 in which a correction value of image data and a detected correction value in a light detecting process to be described later, and an A/D converter 600 that converts an analog signal transmitted from a light receiving sensor 105 built in the optical head 100 into a digital signal, in addition to the optical head 100. The control circuit 200 controls the above-described units and is responsible for an operation for setting and processing a correction value of the image data to be described later.

The optical head 100 includes a plurality of OLED elements 106 as light emitting elements, a TFT control circuit 104 configured by TFTs, drive circuits 107 each formed of a pixel circuit 108 as a unit for driving each OLED element 106 to emit light, in addition to the light receiving sensor 105. The above-described constituent elements of the optical head are formed on the transparent substrate 13 such as glass. As described above, by forming the light receiving sensor 105 on the substrate 13 in which the OLED elements 106 are formed, an advantage that the amount of captured light is large at a time when the amount of light is detected can be acquired. In addition, a part of the drive circuit such as the control circuit 200 may be formed on the substrate 13 in which the OLED elements 106 are formed or may be built in a different print board or the like to be formed.

In the image forming apparatus according to this embodiment, a process for setting a correction value that is used for correcting the image data and a print process in which the image data is corrected and printed by using the set correction value are performed in accordance with the degradation state of each OLED element 106 for emission intensity. Thus, first, an operation of the print process will be described, and then, a process for setting the correction value will be described.

### Operation for Print Process

In the EEPROM 500, correction values used for correcting image data of each dot, that is, each OLED element 106 are stored. The correction values are transferred to a correction register 201 of the control circuit 200 when power is input. The control circuit 200 generates emission control data of 8 bits by using a correction LUT (lookup table) 202 based on the original image data (binary data of On (1) or Off (0)) input from an external circuit not shown in the figure and the correction value (4 bits/dot) for each dot stored in the correction register 201 and outputs the emission control data to the driver 300.

When the original data is On, the emission control data is different for dots to be formed, that is, the OLED elements 106. On the other hand, when the original image data is Off, the emission control data is Off data, and accordingly, the emission control data is the same for all the dots regardless of the correction values. The reason is as follows. While a correction process is needed in response to irregularity of emission intensities of the OLED elements 106 for a case where emission is turned on, a correction process is not needed for a case where emission is turned off.

The reason why the width (4 bits) of the correction value is not the same as the width (8 bits) of the emission control data is that the input voltage—output current characteristic of the pixel circuit 108 to be described later is not linear. The data input from the external circuit includes text data, chart data, and the like other than the image data. However, any type of data can be represented in a two-dimensional matrix data in the process of the optical head, and thus, in descriptions here, all the data is represented as image data.

The driver 300 generates an analog voltage in response to the input emission control data of 8 bits. The emission control data, that is, the generated analog voltage output from the driver 300 is input to the TFT control circuit 104 of the optical head 100. The TFT control circuit 104 distributes the analog voltage to the pixel circuits 108 of the drive circuit 107. Although not described here in detail, as a circuit for implementing a function for distributing data, a circuit that uses a demultiplexer, a shift register, or the like is widely known. In this embodiment, such a circuit can be used.

In each pixel circuit 108 of the drive circuit 107, by supplying a current corresponding to the input analog voltage to the OLED element 106, the emission intensity of the OLED element 106 changes in accordance with the supplied current. Accordingly, the OLED element 106 emits light at the emission intensity corresponding to the analog voltage generated by the driver 300.

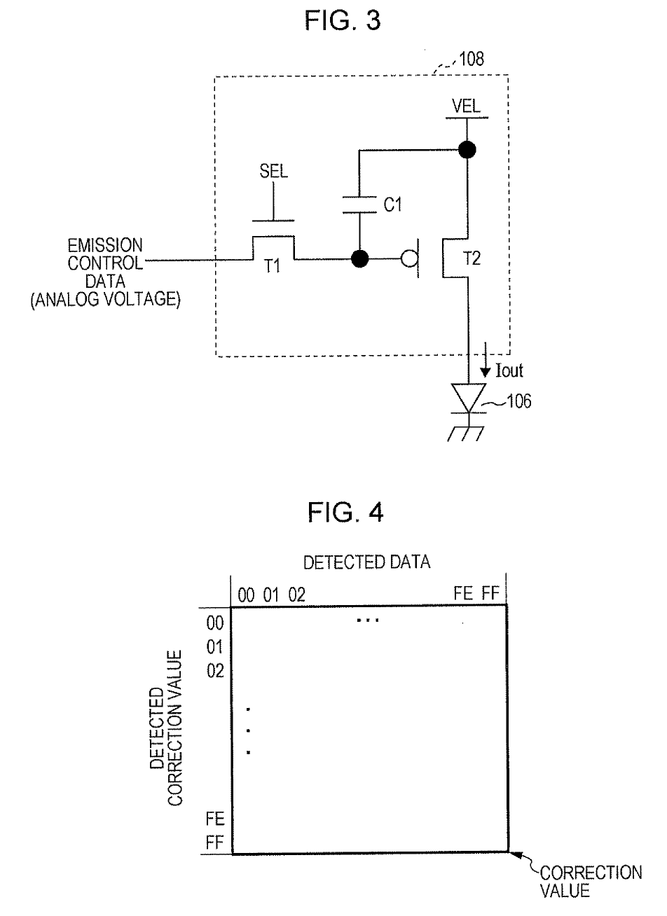

FIG. 3 is a diagram representing a circuit diagram of the pixel circuit 108, and the pixel circuit is the same as a circuit generally known as an OLED display or the like. While a switching transistor T1 is selected by a SEL terminal to be turned on, an analog voltage corresponding to the emission control data is stored in a capacitor C1. A driving transistor T2 outputs a constant current corresponding to the voltage stored in the capacitor C1 from a VEL terminal to the OLED element 106. At this moment, when the original data is On and the OLED element 106 allowed to emit light, the analog voltage that is generated in correspondence with the emission control data is a voltage corresponding to the correction value and is a voltage that allows a driving transistor T2 to operate in a saturated region. On the other hand, when the original image data is Off and the OLED element 106 is not allowed to emit light, the analog voltage that is generated in correspondence with the emission control data is a voltage that allows the driving transistor T2 to be turned off. Accordingly, in that case, the analog voltage does not depend on the correction value.

As described above, the emission intensity of the OLED element 106 slowly decreases in accompaniment with emission time thereof. Accordingly, the emission intensity of the OLED element decreases in correspondence with the use time of the optical head 100. In addition, the use frequencies of the OLED elements 106 are different from one another in accordance with the image data, and accordingly, the decreased amounts of the emission intensities of the OLED elements 106 are different from one another. In other words, there are problems that the absolute emission intensities of the OLED elements 106 decrease in correspondence with use of the optical head 100 and differences of relative emission intensities of the OLED elements 106 are generated on the inside of the optical head 100 at the same time. The former problem affects the overall density in a printing process, and the latter problem causes line-shaped unevenness in the printing process.

Thus, in this embodiment, the decreases in the absolute emission intensities of the OLED elements 106 are controlled, so that use of the optical head 100 for a long time does not affect the printing process. In addition, in this embodiment, in order to suppress the line-shaped unevenness caused by differences of the relative emission intensities in the optical head 100, a configuration in which the emission intensities of the OLED elements 106 are detected, the result of detection is feedback as correction values, and the emission intensities of the OLED elements 106 are controlled to be corrected is used.

### Operation for Correction Value Setting Process

Now, control of detection of emission of each OLED element 106 will be described. By using the light receiving sensor 105 that is formed on the substrate 13 of the OLED element 106, light emitted from each OLED element 106 is detected in the form of a current or a voltage. In this embodiment, light emitted from one OLED element 106 is detected by using a plurality of the light receiving sensors 105. Accordingly, improvement of the precision of detection can be expected. Basically, one light receiving sensor 105 may be configured to detect light from one OLED element 106.

The detected current or voltage of the light receiving sensor 105 is output to the A/D converter 600 that is installed to the outside of the optical head 100. In this embodiment, it is assumed that an average of detected values of the plurality of the light receiving sensors 105 is output. Basically, it may be configured that detected values of the light receiving sensors 105 are multiplied by weighting factors in correspondence with the installed positions, the sensitivities, and the like of the light receiving sensors 105.

The A/D converter 600 converts the currents or voltages output from the light receiving sensors 105 into digital values and outputs the converted digital values to the control circuit 200. The control circuit 200 generates correction values (4 bits/dot) of 4 bits for the OLED elements 106 based on the detected data converted into digital values and the detected correction values of the OLED elements 106 which are stored in a detection-correction register 203 and stores the correction values in the correction register 201 and the EEPROM 500. In addition, in the detection-correction register 203, the detected correction values read out from the EEPROM 500 are stored in advance (at a time when power is input to the image forming apparatus or a detection control process to be described later is started).

Here, an algorithm of the detection control process and the correction control process will be described in detail. The detection control process is a control process until correction values used for correcting the image data are derived from the detected data and detected correction values by using a detection-correction LUT 204. In addition, the correction control process is a control process until emission control data is generated based on the image data and the correction values by using the correction LUT 202.

First, the detection control process until the correction values used for correcting image data are derived from the detected data and the detected correction values by using the detection-correction LUT 204 will be described.

FIG. 4 is a schematic diagram showing the detection-correction LUT 204. As shown in the figure, the detection-correction LUT 204 is a table from which a correction value (4 bits) corresponding to the width (8 bits) of the detected data of the emission intensity of each OLED element 106 and the width (8 bits) of the detected correction value which are detected by the light receiving sensor 105 and the A/D converter 600 can be assigned. Accordingly, a correction value corresponding to the detected data for one OLED element 106 and the detected correction value of the one OLED element 106 can be assigned.

Here, the detected correction value will be described. The detected correction value is a value used for correcting a detection error generated between the exposure intensity on a photosensitive body that is exposed by light emission of each OLED element 106 and detected data of light transmitted from the OLED element 106. In other words, the detected correction value is a value representing correlation between the exposure intensity on the photosensitive body for each OLED element 106 and the detected data.

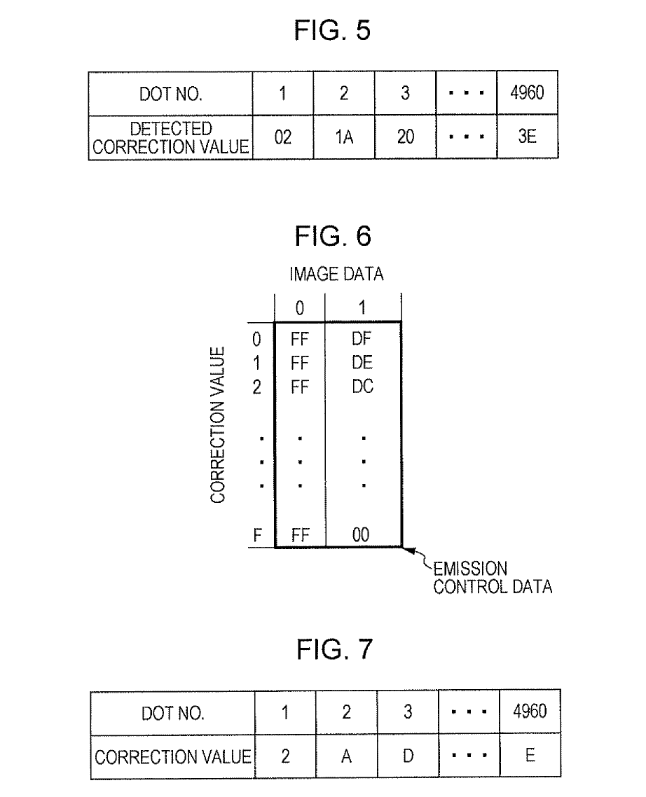

As a detection error, the following is considered. The irregularities of the light emitting sensors 105 and the A/D converters 600 are included in the detected data. In addition, when the number of the disposed light receiving sensors 105 is smaller than the number of the OLED elements 106 or positional relationships between the OLED elements 106 and the light receiving sensors 105 are not fixed, the irregularity of the detected data in each dot occurs based on a distance from the OLED element 106 to the light receiving sensor 105 or the like. However, since the light receiving sensors 105 are disposed on the substrate 13, the irregularity of the characteristics of light paths in the light-harvesting array 11 is not included. The detected correction value is used for correcting the above-described irregularities. As the detected correction value, as shown in FIG. 5, a dot No., that is, a value corresponding to each OLED element 106 is set, and the detected correction value is stored in the detection-correction register 203.

As the detected correction value, a value that is precisely measured before shipment can be used. In particular, after the optical head 100 is manufactured and the light-harvesting lens array 11 is assembled, the amount of light emission of each OLED element 106 is precisely measured by using a jig or the like. At this moment, a correction control process is performed such that light output from the OLED elements 106 is set to have a same exposure intensity on a virtual photosensitive body. In this state, by outputting detected data to each OLED element 106 by using the light receiving sensors 105 and the A/D converters 600, detection of the amount of light can be performed under a condition (a condition that is the same as the exposure condition on the photosensitive body) including the irregularity of the light-harvesting lens array 11, without including the irregularities of the light receiving sensors 105 and the A/D converters 600. The measurement before shipment may be performed in accordance with a plurality of emission intensities. In such a case, the precision of detection can be improved. In this case, since there is a plurality of detected correction values corresponding to the plurality of emission intensities for each OLED element 106, there are detected correction values of two dimensions.

Accordingly, in the detection control process, a correction value that can be assigned to each OLED element 106 for the detected data for each OLED element 106 which is detected at a detection timing to be described later and the detected correction value corresponding to the OLED element 106 having the detected data are derived as the correction value of the OLED element 106 by using the detection-correction LUT 204.

Here, in this embodiment, as described above, the correction value that can be allocated is a correction value of 4 bits for the detected data of 8 bit-width and the detected correction value of 8 bit-width. This reason is that, after a correction value with high precision is calculated based on the detected data (8 bits) having high precision and a detected correction value (8 bits) having high precision, the lower bits are cut away so as to acquire a final correction value (4 bit). Accordingly, the correction value is linear 4-bit data.

By performing a series of the above-described detection control processes, it is possible to derive correction values for acquiring the same exposure intensity on the photosensitive drum 12. In addition, by using the correction values that are derived by the detection control process, the data stored in the EEPROM 500 and data stored in the correction register 201 are updated.

Next, a control process until the emission control data is generated based on the image data and the correction value by using the correction LUT 202 will be described. FIG. 6 is a schematic diagram showing the correction LUT 202. In the correction LUT 202, emission control data used for correcting image data in accordance with irregularity of the characteristics of the OLED elements 106 is set for each OLED element 106 in correspondence with the image data.

The image data is binary (1 and 0) data used for controlling each OLED element 106 to emit light or not in correspondence with a dot to be formed. As one correction value, as shown in FIG. 7, a dot No, that is, a value corresponding to each OLED element 106 is set and stored in the correction register 201. The correction values, as described above, are values used for allowing the OLED elements 106 to emit light with a uniform emission intensity.

In this embodiment, the correction LUT 202 is acquired by implementing a gamma characteristic or a quadratic characteristic, which is a non-linear characteristic, to the linear correction value of 4 bits and generating and assigning the emission control data of 8 bits. Accordingly, the data stored in the EEPROM 500 is not the emission control data of 8 bits but a correction value of 4 bits. Thus, in the optical head 100 that is built in an image forming apparatus (for example, a printer) that performs a printing process, for example, of 600 dpi in size A4, the number of the OLED elements 106 is about 5,000 (in this embodiment, 4,960). By decreasing the amount of data of the correction value stored in each of all the OLED elements 106 (that is, dots of Nos. 1 to 4960) by half, the storage amount and the load of the correction process can be decreased. In addition, circuits formed in the light emitting device 10 can be simplified.

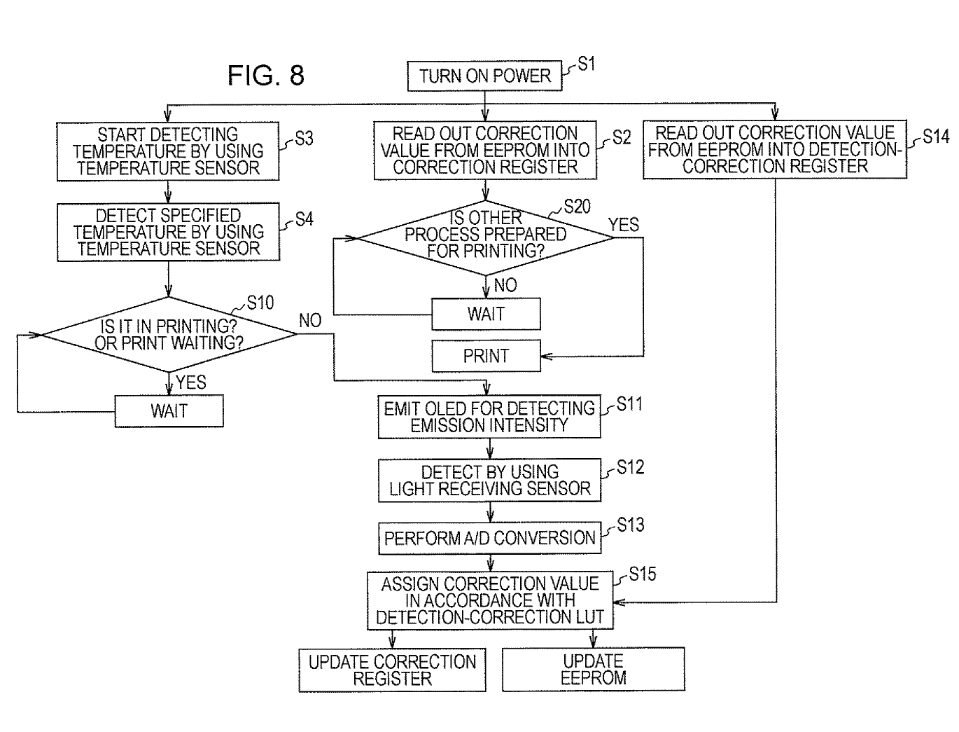

In addition, timings for performing the detection control process and the correction control process, which are described above, will be described with reference to a flowchart shown in FIG. 8. First, the power of the light emitting device 10 is turned on together with turning on the power of the image forming apparatus (for example, a printer) (Step S1). Next, the light emitting device 10 reads a correction value from the EEPROM 500 into the correction register 201 as a preparatory process for performing a printing process based on the print data including image data transmitted from the external circuit (Step S2). Simultaneously with the above-described process or in a state in which the reading process is settled for the time being, the control circuit 200 allows the temperature sensor 400 to start detecting a temperature (Step S3). In a step in which read-out of the correction value into the correction register 201 is completed, when the printing process is prepared in the image forming apparatus including the light emitting device 10 (Step S20: Yes), the printing process is performed based on the image data transmitted from the external circuit.

Commonly, since a high temperature is needed to be applied to the image forming apparatus in a fixing process, a function for warm-up, that is, a mechanism that intentionally dissipates heat is included inside the image forming apparatus. In other words, the temperature inside the image forming apparatus rapidly changes in a small time interval from the input of power to the image forming apparatus. For example, when the above-described detection control process is performed in this status, the characteristics of the OLED elements have dependence on the temperature as described above, and accordingly, the characteristics of the OLED elements 106 markedly changes in accordance with the temperature. Therefore, it is practically difficult to correctly detect the degraded states of the emission intensities of the OLED elements 106.

Thus, in this embodiment, the detection control process is performed when the temperate detected by the temperature sensor 400 reaches a specified temperature in a case where the temperature of each OLED element 106 is considered to be almost fixed each time in the process for detecting the amount of light. In particular, after the specified temperature is detected by using the temperature sensor 400 (Step S4), the control circuit 200 applies a predetermined voltage to the OLED elements 106 to emit light for detecting the emission intensities in a case where the process is not in a printing process or a print waiting process (Step S10: No) (Step S11). Then, light from each OLED element 106 is detected by using the light receiving sensors 105 (Step S12), and an A/D conversion process is performed for the detected light by using the A/D converter 600 (Step S13). Then, a detected correction value corresponding to the detected data after conversion is acquired by using the detection-correction LUT 204, and the correction value is newly assigned as described above (Step S15). Basically, when the process is in a printing process or a print waiting process (Step S10: Yes), the process waits for completion of the printing process.

The data of the correction register 201 and the data of the EEPROM 500 are updated with the newly assigned correction value. Before a correction value is newly assigned by using the detection-correction LUT 204, the detected correction value is needed to be read (Step S14) from the EEPROM 500 into the detection-correction register 203. However, the above-described process is performed in advance without waiting reach of the temperature of the inside of the image forming apparatus to the specified temperature. In this embodiment, although the detection control process is performed after waiting execution of the printing process that is in the waiting state, the detection control process may be performed by intercepting the printing process.

According to the configuration of this embodiment, in order to detect the emission intensities of the OLED elements 106, the light receiving sensors 105 are disposed inside the substrate 13. In addition, in order to prevent a decrease in the precision of detection due to characteristic differences of the light receiving sensors 105, the characteristic differences of the A/D converters 600, a difference between the exposure intensity on the photosensitive body and the intensity of light incident to the light receiving sensor 105 disposed inside the substrate 13, and the like, the detection-correction LUT 204 is disposed. Accordingly, even when an OLED element 106 in which degradation of the amount of light occurs in proportion to the emission time is used, the total decrease of the emission intensity of the optical head 100 can be suppressed, and the irregularity of exposure intensities for dots formed by emission of each OLED element 106 can be suppressed.

In addition, according to this embodiment, the timing for the detection control process is defined by using the temperature sensor 400. Accordingly, even when an OLED element 106 of which emission intensity markedly changes in accordance with the temperature is used, the detection control process is performed under a constant condition (temperature) all the time. As a result, it is possible to correctly detect the degradation of the emission intensity of the OLED element 106.

### Second Embodiment

In the above-described first embodiment, the timing for performing the detection control process is defined in accordance with the temperature detected by the temperature sensor 400. However, in a second embodiment of the invention, the timing for performing the detection control process is defined by acquisition of data used for calculating the number of times of emission, which is related with the emission time of the OLED element 106, in addition to the temperature detected by the temperature sensor 400.

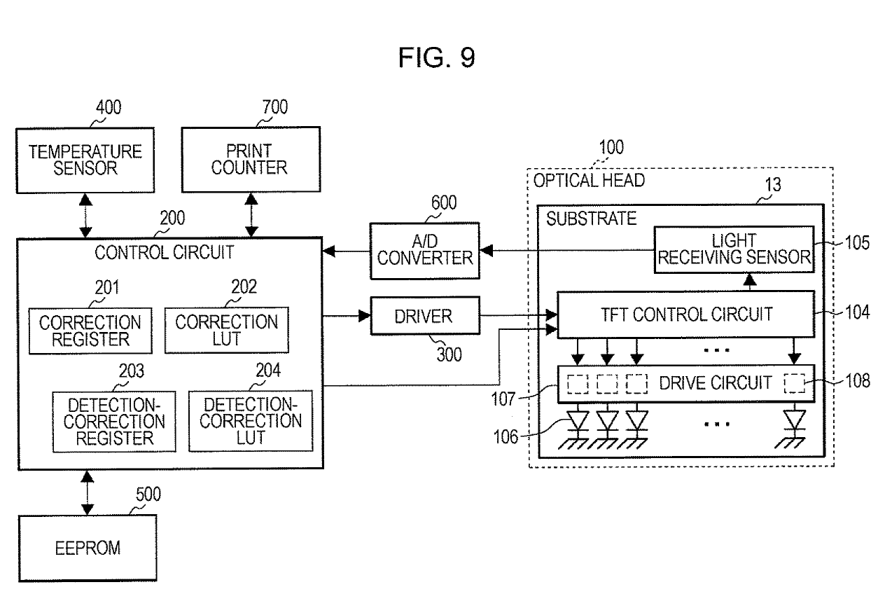

FIG. 9 is a diagram showing the schematic configuration of a light emitting device 10 according to the second embodiment. As shown in the figure, this embodiment has a configuration in which a print counter 700 as a unit for acquiring data used for calculating the number of times of light emission of the OLED element 106 is added to the light emitting device 10 according to the first embodiment. The other configurations of the second embodiment are the same as those of the first embodiment, and thus, a description thereof is omitted here.

The print counter 700 counts the number of sheets printed after input of the power or the number of times of turning on each OLED element 106 after input of the power. Then, the print counter 700 inputs the count data to the control circuit 200. The control circuit 200 performs a detection control process and a correction control process in accordance with the input count data.

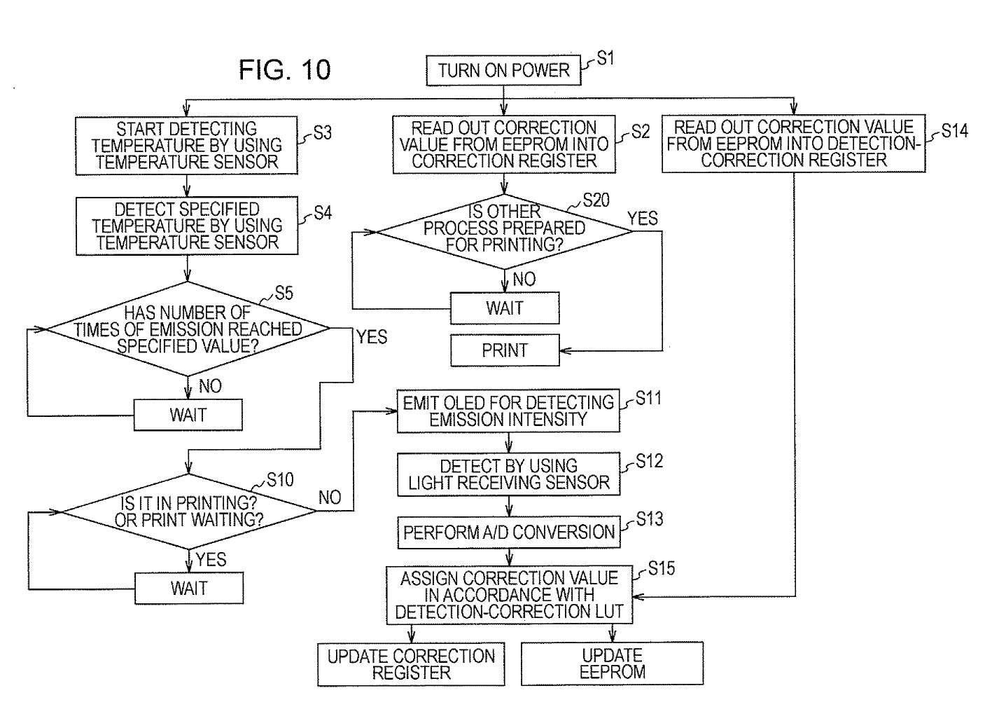

The timings for performing the detection control process and the correction control process according to this embodiment will be described with reference to a flowchart shown in FIG. 10. As shown in FIG. 10, step S5 is added to the flowchart (see FIG. 8) representing the timings for performing the detection control process and the correction control process according to the first embodiment.

First, the power of the image forming apparatus (for example, the printer) and the power of the light emitting device 10 are turned on (Step S1). Next, the light emitting device 10 reads a correction value from the EEPROM 500 into the correction register 201 as a preparatory process for performing a printing process based on the print data transmitted from an external circuit (Step S2). Simultaneously with the above-described process or in a state in which the reading process is settled for the time being, the control circuit 200 allows the temperature sensor 400 to start detecting a temperature (Step S3). In a step in which read-out of the correction value into the correction register 201 is completed, when the printing process is prepared in the image forming apparatus including the light emitting device 10 (Step S20: Yes), the printing process is performed based on the image data transmitted from the external circuit. Simultaneous with the printing process, the printer counter 700 counts the number of accumulated printing states after input of the power. Then, when the number of times of light emission is determined to reach a specified number (Step S5: Yes) as the result of determination on the basis of the counted number, the process proceeds to Step S11, and performs processes thereafter.

As described above, according to this embodiment, in a step in which both a condition, in which the temperature detected by the temperature sensor 400 reaches the specified temperature, and a condition, in which the counted number of the accumulated prints reaches the specified counted number, are cleared, the detection control process is performed. The temperature characteristic of the OLED element 106 changes in accordance with not only the temperature of the inside of the image forming apparatus but also the temperature of the inside of the substrate 13. Thus, according to this embodiment, the detection control process is performed after the number of times of emission of the OLED element 106 reaches the specified number and the inside of the substrate 13 is sufficiently warm. Accordingly, it is possible to perform the detection control process without being affected by the temperature characteristic of the OLED element 106.

In this embodiment, the timing for performing the detection control process is defined by using the temperature sensor 400 and the print counter 700. Accordingly, even when an OLED element 106 that markedly changes in accordance with the temperature is used, the detection control process is performed under a constant condition (temperature), and accordingly, it is possible to detect unmixed degradation of the emission intensity of the OLED element 106.

### Third Embodiment

Next, a third embodiment of the invention will be described. In the above-described first and second embodiments, the detection control process and the correction control process are performed after the temperature detected by the temperature sensor 400 reaches one specified temperature (for example, 30° C.), so that the detection control process can be performed under a constant condition (temperature). However, in the third embodiment, the detection control process and the correction control process are also performed at a temperature other than the specified temperature.

For example, when the temperature of the image forming apparatus in which the light emitting device 10 is built gradually rises, a time required for reaching the specified temperature is lengthened. Accordingly, in a printing process that is performed until the specified temperature is detected, a state in which the emission intensity cannot be correctly corrected occurs frequently. In addition, for example, when the temperature at the time of use changes in accordance with the season or the environment of installment, the temperatures of the OLED elements 106 in the printing process are different from the specified temperature, and accordingly, there is a case where the image data cannot be corrected correctly.

Thus, when the correction process is configured to be performed at a plurality of specified temperatures instead of one specified temperature, the correction process can be performed at the range of temperatures of the light emitting device at the time of use. Accordingly, even when the considered range of temperatures at the time of use is long, it is possible to generate the emission control data by correctly correcting the image data.

In this embodiment, two cases including a case where the detection control process and the correction control process are performed at a plurality of specified temperatures and a case where the detection control process and the correction control process are performed at an arbitrary temperature will be described as examples. In addition, according to this embodiment, the configuration of the light emitting device 10 is the same as that of the above-described first or second embodiment. In addition, the timings for performing the detection control process and the correction control process are the same as those of the first or second embodiment. Thus, a description thereof is omitted here.

### Plurality of Specified Temperatures

The detection control process according to this embodiment will be described with reference to FIG. 8 that represents the flowchart of the above-described first embodiment, as an example. According to this embodiment, in the specified temperature detecting process of Step S4, any one of four specified temperatures of 10° C., 20° C., 30° C., and 40° C. is detected. Then, the correction values of the OLED elements 106 are derived based on the detected data acquired in the processes of Step S11 to Step S13 for each OLED element 106 and detected correction values stored in the detection-correction register by using the detection-correction LUT 204 that is set for each detected specified temperature.

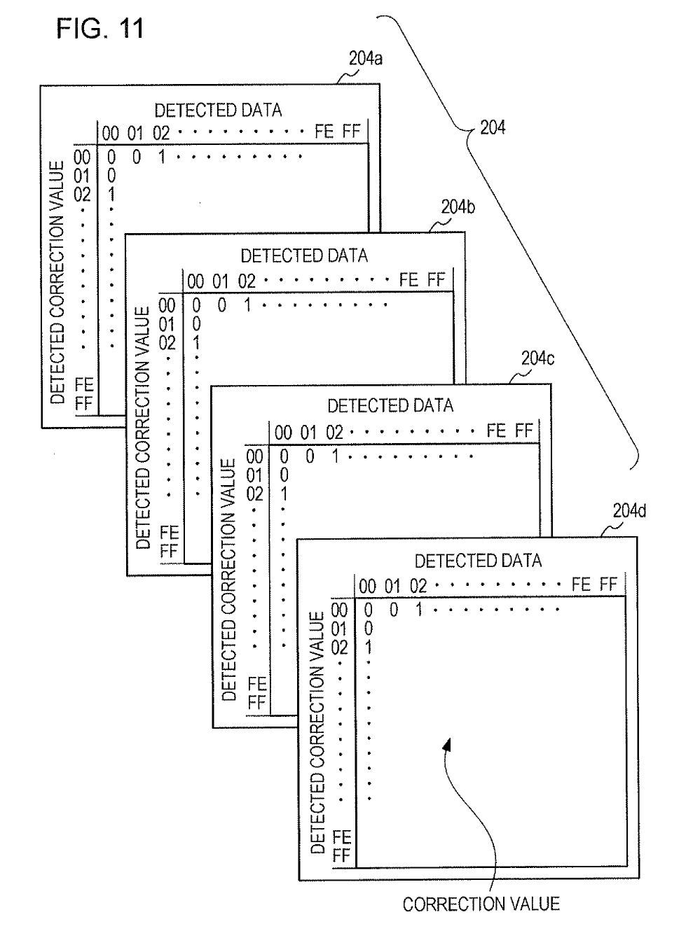

According to this embodiment, in the control circuit 200, as shown in FIG. 11, four detection-correction LUTs 204a, 204b, 204c, and 204d corresponding to the specified temperatures of 10° C., 20° C., 30° C., and 40° C. are included. In other words, correction values corresponding to all the detected data and all the detected correction values are assigned for each specified temperature in accordance with the temperature characteristic of each OLED element 106. Accordingly, in the detection control process, corrected values used for correcting the image data can be derived based on the detected data and the detected correction value by using the detection-correction LUT 204 corresponding to the specified temperature that is detected by the temperature sensor 400.

In addition, in this embodiment, it is preferable that values precisely measured before shipment are used as the detected correction values. In particular, after the optical head 100 is manufactured and the light-harvesting lens array 11 is assembled, the amount of light emission of each OLED element 106 is precisely measured by using a jig or the like. At this moment, a correction control process is performed such that light output from the OLED elements 106 is set to have a same emission intensity on a virtual photosensitive body. In this state, by outputting detected data to each OLED element 106 by using the light receiving sensors 105 and the A/D converters 600, detection of the emission amount can be performed under a condition (a condition that is the same as the exposure condition on the photosensitive body) including the irregularity of the light-harvesting lens array 11, without including the irregularities of the light receiving sensors 105 and the A/D converters 600.

By performing a series of the above-described detection control processes, it is possible to derive correction values for acquiring the same exposure intensity on the photosensitive drum 12 at each specified temperature. In addition, by using the correction values that are derived by the detection control process, the data stored in the EEPROM 500 and the data stored in the correction register 201 are updated.

In addition, in this embodiment, the temperature detecting process (Step S4) may be configured to be performed continuously. When a newly specified temperature is detected in Step S4, a process in which correction values for correcting the image data are derived based on the detected data and the detected correction value by using the detection-correction LUT 204 corresponding to a newly detected specified temperature is repeatedly performed. For example, when the newly detected temperature is 40° C., the correction values are derived by using the detection-correction LUT 204d corresponding to 40° C. Thereafter, the correction control process until the emission control data is generated based on the correction values is the same as that of the first or second embodiment.

Although the detection-correction LUTs 204 corresponding to the specified temperatures are included in this embodiment, the invention is not limited thereto. For example, it may be configured that, by performing a predetermined calculation process for the detection-correction LUT 204 that is set for one specified temperature, the detection-correction LUT 204 for a different specified temperature is generated. When relationship between each specified temperature and the emission intensity of each OLED element 106 for the specified temperature can be represented by a coefficient (for example, a temperature coefficient), a detection-correction LUT 204 corresponding to a different specified temperature can be generated by performing the calculation process as described above.

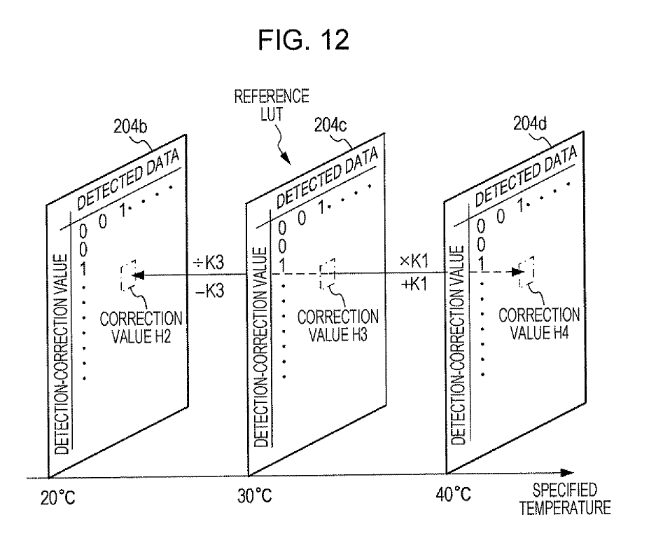

As an example, a case where a detection-correction LUT 204c corresponding to a specified temperature of 30° C. is used as a reference LUT and detection-correction LUTs 204b and 204d corresponding to specified temperatures of 20° C. and 40° C. are generated by performing a calculation process using a temperature coefficient for the detection-correction LUT 204c is represented in FIG. 12. In particular, each correction value assigned in the detection-correction LUT 204c corresponding to 30° C. is multiplied or divided by a temperature coefficient K1 or a temperature coefficient K2 is added to or subtracted from the correction value H3, for calculating correction values H4 and H2 that are to be assigned in the detection-correction LUT 204d and the detection-correction LUT 204b corresponding to 40° C. and 20° C. Then, the detection-correction LUT 204d and the detection correction LUT 204b corresponding to 40° C. and 20° C. are generated. Accordingly, although the scale of the circuit is increased for performing the calculation process, the occupied storage capacity can be decreased by the amount of storage used for storing the detection-correction LUT 204b and the detection-correction LUT 204d.

### Arbitrary Temperature

The detection control process according to this embodiment will be described with reference to FIG. 8 that represents steps according to the first embodiment as an example, similarly to the plurality of specified temperatures. According to this embodiment, in the specified temperature detecting process of Step S4, not a predetermined temperature as a specified temperature but a temperature after elapse of a predetermined time from start of detection is detected. Accordingly, the detected temperature is an arbitrary temperature, which is different from a case where a specified temperature is detected. Then, correction values for the OLED elements 106 at the detected arbitrary temperature are derived by using the detection correction LUT 204 corresponding to the arbitrary temperature based on the detected data that can be acquired by performing processes of Steps S11 to S13 for the OLED elements 106 and detected correction values stored in the detection-correction register 203.

In this embodiment, the control circuit 200 has a function for generating a detection-correction LUT 204n corresponding to any arbitrary temperature. In other words, a detection correction LUT 204 corresponding to one reference temperature or a plurality of reference temperatures is included, and a detection-correction LUT 204n for a detected temperature is generated by performing a predetermined calculation process for the included detection-correction LUT 204. When relationship between the emission intensity of each OLED element 106 and the temperature can be represented by a coefficient (for example, a temperature coefficient), the detection-correction LUT 204n for any arbitrary temperature can be generated by performing the calculation process as described above by using the detection-correction LUT 204 for the reference temperature. Accordingly, although the scale of the circuit is increased for performing the calculation process, the occupied storage capacity can be decreased by the amount of storage used for storing the detection-correction LUT 204n for the arbitrary temperature. In addition, the reference temperature may be the above-described specified temperature.

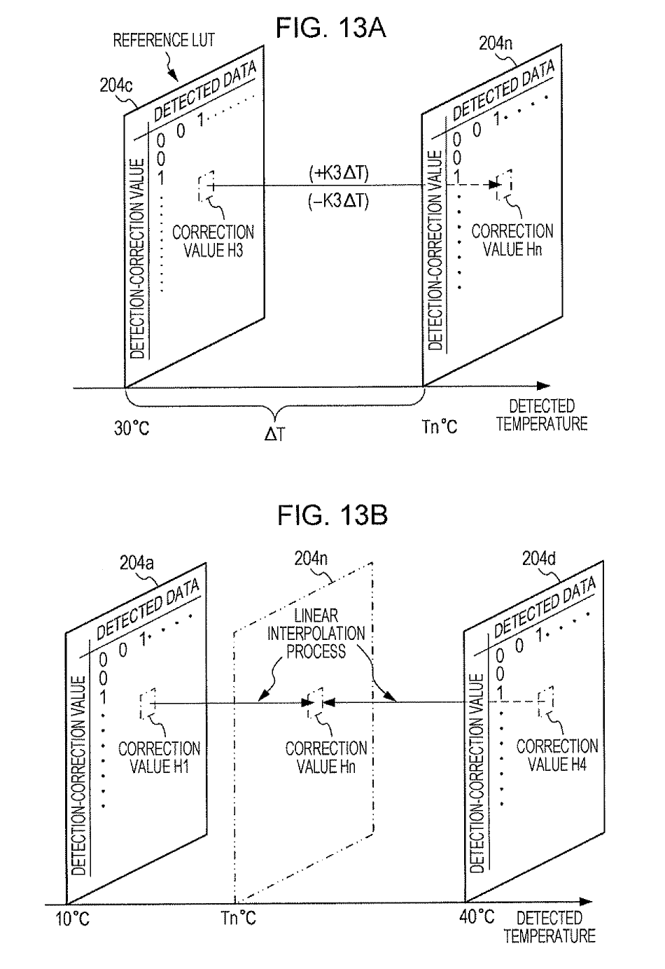

An example of a method of generating the detection-correction LUT 204n corresponding to the arbitrary temperature according to this embodiment is represented in FIGS. 13A and 13B. FIG. 13A is a schematic diagram representing appearance of calculating and generating a correction value Hn of the detection correction LUT 204n corresponding to the arbitrary temperature Tn° C. based on the correction value H3 of the detection-correction LUT 204c corresponding to one reference temperature of 30° C. For example, in a case where the emission intensity of each OLED element 106 changes with respect to the temperature in correspondence with a line, a case where the detection-correction LUT 204n corresponding to the arbitrary temperature Tn° C. is generated by acquiring the correction value Hn by adding or subtracting a value resulted from multiplying a temperature coefficient K3 that is the slop of the line by a temperature difference ΔT between the detected temperature and the reference temperature (30° C.) to or from the correction value H3 is represented. In addition, in a case where the emission intensity of each OLED element 106 is in proportion to the temperature, the detection-correction LUT 204n corresponding to the arbitrary temperature may be generated by acquiring the correction value Hn by multiplying or dividing the correction value H3 of the detection-correction LUT 204c corresponding to the reference temperature of 30° C. by a temperature coefficient.

FIG. 13B is a schematic diagram representing appearance of calculating and generating the detection-correction LUT 204n corresponding to the arbitrary temperature Tn based on the detection-correction LUT 204a and the detection-correction LUT 204d corresponding to two reference temperatures (10° C. and 40° C.) as an example of the plurality of reference temperatures. As shown in the figure, a case where the detection-correction LUT 204n corresponding to the arbitrary temperature Tn is generated by acquiring a correction value Hn corresponding to the arbitrary temperature Tn by performing linear interpolation between the correction value H1 of the detection correction LUT 204a corresponding to the reference temperature of 10° C. and the correction value H4 of the detection correction LUT 204d corresponding to the reference temperature of 40° C. is represented. The interpolation is not limited to linear interpolation and may be nonlinear interpolation.

Accordingly, in the detection control process, correction values used for correcting the image data can be derived based on the detected data and the detected correction value by using the detection correction LUT 204n corresponding to the arbitrary temperature that is detected by the temperature sensor 400. As a result, the correction values for any arbitrary temperature that is used for acquiring a same exposure intensity on the photosensitive drum 12 can be derived by performing a series of detection control processes. Then, the data stored in the EEPROM 500 and the data stored in the correction register 201 are updated with the correction values that are derived by the detection control process.

In addition, in this embodiment, the temperature detecting process (Step S4) may be configured to be performed continuously. When a new temperature is detected in Step S4, a detection-correction LUT 204 corresponding to the detected new temperature is generated by performing a calculation process, and a process in which correction values used for correcting the image data are generated based on the detected data and the detected correction value is repeatedly performed. Thereafter, the correction control process until the emission control data is generated based on the correction values is the same as that of the first or second embodiment.

### MODIFIED EXAMPLE

The invention is not limited to the above-described embodiments, and, for example, changes in the form as below can be made therein. In addition, among the modified examples represented below, two or more modified examples may be combined together.

### Modified Example 1

In the above-described embodiments, the detected correction values are configured to be stored in the EEPROM 500 in the same manner as for the correction values. However, the invention is not limited thereto. Thus, the detected correction values may be configured to be stored in a read only memory (ROM) that cannot be rewritable after shipment. Since the detected correction values are not updated after shipment, differently from the correction values, the detected correction values are configured to be stored in a non-volatile memory. The detected correction values are determined to be stored in either the EEPROM 500 or another ROM in consideration of the entire system.

### Modified Example 2

In the above-described embodiments, the emission control data acquired by correcting the image data by using the correction values is configured to be supplied to the optical head 100. However, it may be configured that the correction values are stored in the optical head 100 and a process for correcting the image data is performed inside the optical head 100. In such a case, since the output from the driver 300 does not include the contents of correction, the output is binary image data, and a correction memory instead of the correction reregister is configured to be disposed inside the optical head 100.

### Modified Example 3

In the above-described embodiments, after the correction value is read into the correction resister 201 and the detected correction value is read into the detection-correction register 203, various control processes are performed. However, various control processes may be configured to be performed not through the correction register 201 or the detection-correction register 203 but through direct communication with the EEPROM 500. In such a case, although there is a disadvantage that a time is required for performing various control processes, a register is not needed to be disposed in the control circuit 200, and accordingly, it is possible to decrease the scale of the circuit.

### Modified Example 4

In the above-described embodiments, a configuration in which the correction LUT 202 and the detection-correction LUT 204 are separately arranged. However, when the function described in each of the above-described embodiments is included, one LUT that combines the correction LUT and the detection-correction LUT may be used.

### Modified Example 5

In the above-described embodiments, the correction LUT 202 and the detection-correction LUT 204 are used in the detection control process and the correction control process. However, when the function described in each of the above-described embodiments is included, the function may be implemented not in the LUTs but in the calculation process. In such a case, although the scale of the circuit is increased, the occupied storage capacity can be decreased by the amount of storage used for storing the LUTS.

### Modified Example 6

In the above-described embodiments, the light emitting element is an OLED element. However, as the light emitting element, an inorganic diode or LED (Light Emitting Diode) may be used. The point is that any element that emits light in accordance with the amount of supply (amount of application of an electric field or supply of a current) of electric energy can be used as the light emitting element.

### Electronic Apparatus

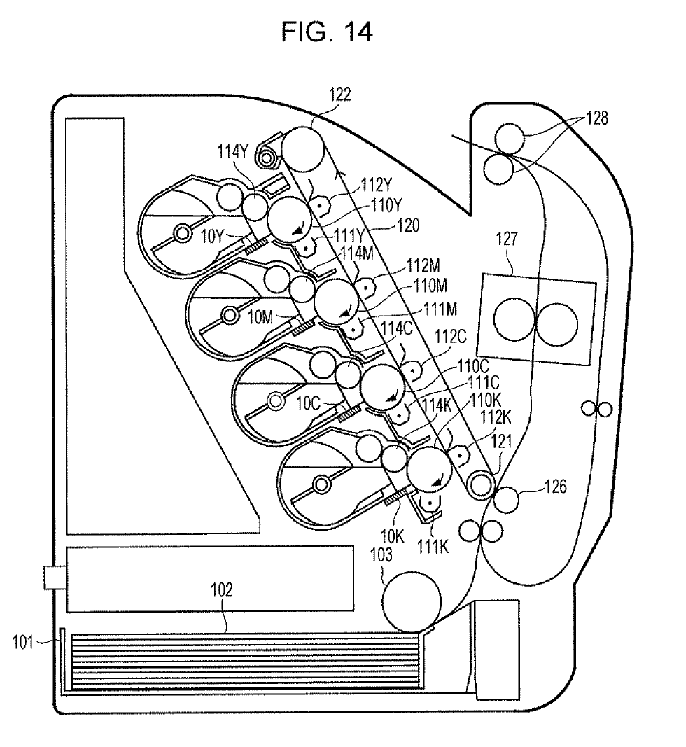

Next, an image forming apparatus as a form of an electronic apparatus according to each of the above-described embodiments will be described with reference to FIG. 14. The image forming apparatus is a full-color image forming apparatus of a tandem type using a belt intermediate transfer body.

In this image forming apparatus, four light emitting devices 10 (10K, 10C, 10M, and 10Y) having a same configuration are disposed in positions for facing imaging surfaces of four photosensitive drums 110 (110K, 110C, 110M, and 110Y) as image carriers having a same configuration. The light emitting devices 10 (10K, 10C, 10M, and 10Y) have a same configuration as that of the light emitting device 10 according to each of the above-described embodiments.

As shown in FIG. 14, in this image forming apparatus, a driving roller 121 and a driven roller 122 are disposed. The driving roller 121 and the driven roller 122 are wound by an endless intermediate transfer belt 120, and the intermediate transfer belt is rotated around the driving roller 121 and the driven roller 122 as denoted by arrows. Although not shown in the figure, a tension unit such as a tension roller that applies tension to the intermediate transfer belt 120 may be disposed.

Near the intermediate transfer belt 120, four photosensitive drums 110 (110K, 110C, 110M, and 110Y) that have photosensitive layers on the outer peripheral faces thereof are disposed with a predetermined gap interposed therebetween. Here, suffixes “K”, “C”, “M”, and “Y” represent that the photosensitive drums are used for forming actual images of a black color, a cyan color, a magenta color, and a yellow color. This applies to other members. The photosensitive drums 110 (110K, 110C, 110M, and 110Y) are driven to rotate in synchronization with driving of the intermediate belt 120.

Near each photosensitive drum 110 (110K, 110C, 110M, and 110Y), a corona charger 111 (111K, 111C, 111M, and 111Y), a light emitting device 10 (10K, 10C, 10M, and 10Y), and a developing device 114 (114K, 114C, 114M, and 114Y) are disposed. The corona charger 111 (111K, 111C, 111M, and 111Y) uniformly charges an imaging face (outer peripheral face) of the photosensitive drum 110 (110K, 110C, 110M, and 110Y) corresponding thereto. The light emitting device 10 (10K, 10C, 1M, and 10Y) writes an electrostatic latent image on the charged imaging surface of each photosensitive drum. In each light emitting device 10 (10K, 10C, 10M, and 10Y), a plurality of light emitting elements 20 is arranged along the bus line (main scanning direction) of the photosensitive drum 110 (110K, 110C, 110M, and 110Y). An operation for writing the electrostatic latent image is performed by projecting light onto the photosensitive drum 110 (110K, 110C, 110M, and 110Y) by using the plurality of light emitting elements 20. The developing device 114 (114K, 114C, 114M, and 114Y) forms an actual image (that is, a visible image) on the photosensitive drum 110 (110K, 110C, 110M, and 110Y) by adhering toner as a developer to the electrostatic latent image.

The actual images of a black color, a cyan color, a magenta color, and a yellow color that are formed by monochrome actual image forming stations of four colors are sequentially transferred on the intermediate transfer belt 120 as a primary transfer process to be overlapped with one another on the intermediate transfer belt 120, and thereby a full-color actual image is formed. On the inner side of the intermediate transfer belt 120, four primary-transfer corotrons 112 (112K, 112C, 112M, and 112Y) as transfer units are disposed. The primary transfer corotrons 112 (112K, 112C, 112M, and 112Y) are disposed near the photosensitive drums 110 (110K, 110C, 110M, and 110). As the primary transfer corotrons electrostatically suck the actual images from the photosensitive drums 110 (110K, 110C, 110M, and 110Y), the actual images are transferred onto the intermediate transfer belt 120 that passes between the photosensitive drums and the primary-transfer corotrons.

Then, a sheet 102 as a target (recording material) for forming a final image is fed from a paper feeding cassette 101 by a pickup roller 103 one after another and is transported in a nip formed between the intermediate transfer belt 120 that is brought into contact with the driving roller 121 and a secondary transfer roller 126. The full-color actual image formed on the intermediate transfer belt 120 is transferred altogether onto one face of the sheet 102 by the secondary transfer roller 126 as a secondary transfer process and is fixed to the sheet 102 by being passed through a fixing roller pair 127 as a fixing unit. Thereafter, the sheet 102 is discharged to a discharge cassette that is formed on the upper part of the device by a discharge roller pair 128.

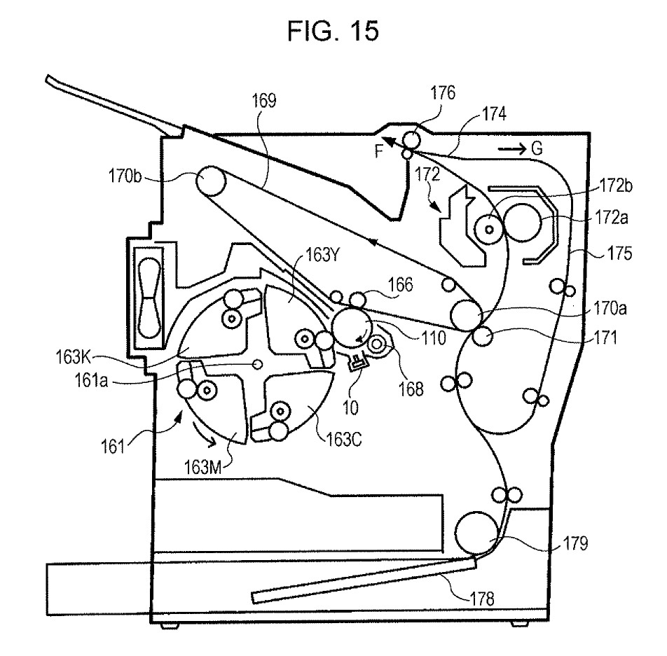

Next, an image forming apparatus according to another embodiment of the invention will be described with reference to FIG. 15. This image forming apparatus is a full-color image forming apparatus of a rotary developing type using a belt intermediate transfer body. As shown in FIG. 15, near a photosensitive drum 110, a corona charger 168, a rotary-type developing unit 161, the light emitting device 10 according to the above-described embodiment, and an intermediate transfer belt 169 are disposed.

The corona charger 168 uniformly charges the outer peripheral face of the photosensitive drum 110. The light emitting device 10 writes an electrostatic latent image onto the charged imaging surface (outer peripheral face) of the photosensitive drum 110. In the light emitting device 10, a plurality of light emitting elements 32 is arranged along the bus line (main scanning direction) of the photosensitive drum 110. The operation for writing the electrostatic latent image is performed by projecting light from the light emitting elements 32 to the photosensitive drum 110.

The developing unit 161 is a drum in which four developing units 163Y, 163C, 163M, and 163K are disposed with an interval of 90° therebetween. The developing unit can be rotated around an axis 161a in the counterclockwise direction. The developing units 163Y, 163C, 163M, and 163K supply toner of a yellow color, a cyan color, a magenta color, and a black color to the photosensitive drum 110, and by adhering toner as a developer to the electrostatic latent image, an actual image (that is, a visible image) is formed on the photosensitive drum 110.

An endless intermediate transfer belt 169 is wound around a driving roller 170a, a driven roller 170b, a primary transfer roller 166, and a tension roller and is rotated around the rollers in the direction denoted by an arrow. The primary transfer roller 166 electrostatically sucks the actual image from the photosensitive drum 110 for transferring the actual image onto the intermediate transfer belt 169 that passes through the photosensitive drum 110 and the primary transfer roller 166.

In particular, by the first rotation of the photosensitive drum 110, an electrostatic latent image for a yellow (Y) image is written by the light emitting device 10, and an actual image of a same color is formed by the developing unit 163Y and then, is transferred onto the intermediate transfer belt 169. In addition, by the next rotation, an electrostatic latent image for a cyan (C) image is written by the light emitting device 10A, and an actual image of a same color is formed by the developing unit 163C. Then, the actual image is transferred onto the intermediate transfer belt 169 to be overlapped with the yellow actual image. Then, while the photosensitive drum 110 is rotated four times as described above, the actual images of yellow, cyan, magenta, and black are sequentially overlapped with one another on the intermediate transfer belt 169. As a result, a full-color actual image is formed on the transfer belt 169. When an image is formed on both sides of one sheet as a final target for forming an image, actual images of a same color are transferred to the front and rear surfaces of the intermediate transfer belt 169, and then, actual images of the next color are transferred onto the front and rear surfaces of the intermediate transfer belt 169. Thereby a full-color actual image is formed on the intermediate transfer belt 169.

In the image forming apparatus, a sheet transport path 174 through which a sheet passes is installed. The sheets are picked up from a paper feeding cassette 178 by a pickup roller 179 one after another, is advanced through the sheet transport path 174 by the transport roller, and passes a nip formed between the intermediate transfer belt 169 that is brought into contact with the driving roller 170a and the secondary transfer roller 171. The second transfer roller 171 transfers the actual image on one surface of the sheet by electrostatically sucking the full-color actual image altogether from the intermediate transfer belt 169. The secondary transfer roller 171 is configured to approach or depart from the intermediate transfer belt 169 by using a clutch not shown in the figure. Then, when the full-color actual image is transferred onto the sheet, the secondary transfer roller 171 is brought into contact with the intermediate transfer belt 169. On the other hand, the secondary transfer roller 171 is departed from the secondary transfer belt 169 while actual images are repeatedly transferred on the intermediate transfer belt 169.

As described above, the sheet on which the actual image is transferred is transported to the fixing unit 172, and by passing the sheet between a heating roller 172a and a pressure roller 172b of the fixing unit 172, the actual image on the sheet is fixed. The sheet after the fixing process is drawn into a discharge roller pair 176 so as to be advanced in the direction of arrow F. For a case where a double-sided printing process is performed, after most of the sheet passes the discharge roller pair 176, the discharge roller pair 176 is rotated in the opposite direction. Accordingly, the sheet is introduced into a transport path 175 for the double-sided printing process as denoted by arrow G. Then, the actual image is transferred onto the other surface of the sheet by the secondary transfer roller 171. After the fixing process is performed for the sheet by using the fixing unit 172 again, the sheet is discharged by the discharge roller pair 176.

The image forming apparatuses shown in FIGS. 14 and 15 as examples use a light source (exposure unit) that employs an OLED element as the light emitting element 20, and accordingly, the apparatuses can be miniaturized, compared to a case where a laser scanning optical system is used. In addition, the light emitting device 10 according to an embodiment of the invention can be employed in an image forming apparatus of a xerographic type. For example, the light emitting device 10 according to an embodiment of the invention can be applied to an image forming apparatus in which an actual image is directly transferred to a sheet from the photosensitive drum without using an intermediate transfer belt or an image forming apparatus that forms a monochrome image.

The use of the light emitting device according to an embodiment of the invention is not limited to exposure of the photosensitive body. For example, the light emitting device according to an embodiment of the invention is employed in an image-reading device such as a scanner as a line-type optical head (luminance device) that projects light onto a reading target such as a document. As image reading apparatuses of this type, there are a scanner, a reading part of a copier or a fax machine, a bar-code reader, and a two-dimensional image code reader that reads a two-dimensional code such as a QR code (registered trademark). In addition, the light emitting device in which a plurality of light emitting elements (particularly, light emitting elements) is disposed on a face thereof can be used as a back light unit that is disposed on the rear side of a liquid crystal panel. In addition, the light emitting device in which a plurality of light emitting elements is arranged in a matrix shape can be used as a display unit of various electronic apparatuses.

The entire disclosure of Japanese Patent Application Nos: 2007-313255, filed Dec. 4, 2007 and 2008-293064, filed Nov. 17, 2008 are expressly incorporated by reference herein.

What is claimed is:

1. A method of driving a light emitting device including:
a light emitting element; and
a unit circuit that is disposed in correspondence with the light emitting element and drives the light emitting element in accordance with emission control data generated based on image data,
wherein the light emitting device has a temperature sensor and a light receiving sensor,
the method comprising:
detecting the temperature of the light emitting device by using the temperature sensor;
detecting light emitted from the light emitting element by using the light receiving sensor; and
generating the emission control data by correcting the image data in response to the temperature of the light emitting device which is detected by the temperature sensor and the detected value of light which is detected by the light receiving sensor.

2. The method according to claim 1, wherein, in the generating of the emission control data, the detected value is converted into an effective value, and the emission control data is generated by using the effective value as the detected value.

3. The method according to claim 1, wherein, in the generating of the emission control data, the emission control data is generated by correcting the image data in response to the detected value such that the correction characteristic for generating the emission control data is non linear.

4. The method according to claim 1,
wherein the light emitting device further includes a light-harvesting lens array that collects light of the light emitting element, and
wherein, in the generating of the emission control data, the image data is corrected in response to the positional relationship between the light emitting element and the light-harvesting lens array.

5. The method according to claim 1,
wherein, in the detecting of the light, the light emitted from the light emitting element is detected by using a plurality of the light receiving sensors, and
wherein, in generating of the emission control data, the image data is corrected in response to detected values detected by the plurality of the light receiving sensors.

6. The method according to claim 1, wherein, in the generating of the emission control data, the image data is corrected by using a conversion table in which a correction value that is used for correcting the image data in response to the detected temperature and the detected value of light is defined.

7. The method according to claim 6, wherein the correction value of the conversion table is acquired by performing a predetermined calculation process for the correction value set for at least one temperature that becomes a reference.

8. The method according to claim 1,
wherein the detecting of the temperature includes detecting whether the temperature of the light emitting device is a specified temperature, and
wherein, in the detecting of the light, after detecting that the temperature of the light emitting device is the specified temperature in the detecting of the temperature, light emitted from the light emitting element is detected.

9. The method according to claim 8, wherein, in the detecting of light, light emitted from the light emitting element is detected at a plurality of the specified temperatures.

10. The method according to claim 1,
wherein the image data is either On data that is used for allowing the light emitting element to emit light or Off data that is used for not allowing the light emitting element to emit light, and
wherein, in the generating of the emission control data, the emission control data is generated by correcting the image data in a case where the image data is the On data, and the emission control data is generated without correcting the image data in a case where the image data is the Off data.

11. The method according to claim 1,
wherein the light emitting device further includes a counter that acquires data used for calculating the number of times of light emission of the light emitting element, and
wherein, in the detecting of light, light emitted from the light emitting element is detected after it is determined that the number of times of the light emission reaches a predetermined number of times based on the acquired data.

12. A light emitting device comprising:
a light emitting element;
a unit circuit that drives the light emitting element to emit light;
a temperature sensor that detects the temperature of the light emitting device;
a light receiving sensor that detects light emitted from the light emitting element; and
a control unit that generates emission control data by correcting image data in response to the temperature of the light emission device which is detected by the temperature sensor and a detected value of light which is detected by the light receiving sensor,
wherein the unit circuit drives the light emitting element to emit light in response to the emission control data that is generated based on the image data.

13. An electronic apparatus comprising the light emitting device according to claim 12.
